(19) United States
(12) Patent Application Publication
(10) Pub. No.: US 2022/0318898 A1
(43) Pub. Date: Oct. 6, 2022

(54) CATEGORIZING TRANSACTION RECORDS

(71) Applicant: Intuit Inc., Mountain View, CA (US)

(72) Inventors: Lei Pei, Sunnyvale, CA (US); Juan Liu, Cupertino, CA (US); Ruobing Lu, Mountain View, CA (US); Ying Sun, Foster City, CA (US); Heather Elizabeth Simpson, Sunnyvale, CA (US); Nhung Ho, Redwood City, CA (US)

(73) Assignee: Intuit Inc., Mountain View, CA (US)

(21) Appl. No.: 17/217,907

(22) Filed: Mar. 30, 2021

(51) Int. Cl. G06Q 40/02; G06N 20/00; G06F 17/16

(52) U.S. Cl. CPC G06Q 40/02; G06N 20/00; G06F 17/16

(57) ABSTRACT

A method categorizes transaction records. A transaction record is received by a server application. The transaction record is encoded with a first machine learning model to obtain a transaction vector, wherein the transaction vector is in a same vector space as multiple account vectors. A second machine learning model executing in the server application, selects an account vector, from the multiple account vectors, corresponding to the transaction vector. An account identifier, corresponding to the account vector, is presented for the transaction record.

### BACKGROUND

Transaction categorization is often an important part of transaction processing. During transaction categorization, transactions are categorized into different accounts in a chart of accounts. The chart of accounts includes multiple financial accounting accounts that are used in generating financial reports and understanding an entities' finances. In order to properly assess the entity's finances, transactions should be accurately categorized.

Because of the number of transactions, computer systems assist by performing automated transaction categorization. In a computer, automated transaction categorization methods enhance user experience by reducing the need for tedious manual transaction review and categorization. A challenge exists when an entity is new and has limited, if any, transactions categorized.

### SUMMARY

In general, in one or more aspects, the disclosure relates to a method of categorizing transaction records. A transaction record is received by a server application. The transaction record is encoded with a first machine learning model to obtain a transaction vector, wherein the transaction vector is in a same vector space as multiple account vectors. A second machine learning model executing in the server application, selects an account vector, from the multiple account vectors, corresponding to the transaction vector. An account identifier is presented corresponding to the account vector for the transaction record.

In general, in one or more aspects, the disclosure relates to a system that categorizes transaction records and includes a server comprising one or more processors and one or more memories and an application, executing on one or more processors of the server. A transaction record is received, by the application. A transaction vector is generated from the transaction record with a transaction model. An account vector, from a plurality of account vectors, corresponding to the transaction record is selecting, by a match model executing in the application, using the transaction vector and the account vector. The account vector is generated using an account embedding model. An account identifier, corresponding to the account vector, is presented for the transaction record.

In general, in one or more aspects, the disclosure relates to a method that trains and uses machine learning models. A transaction model is trained to generate a plurality of transaction vectors from a plurality of transaction records using an update function of the transaction model. The match model is trained to generate match scores from the plurality of transaction vectors and a plurality of account vectors using an update function of the match model. A transaction vector, of the plurality of transaction vectors, is generated with the transaction model from a transaction record of the plurality of transaction records. An account vector, from a plurality of account vectors, corresponding to the transaction record is selecting, by the match model executing in a server application, using the transaction vector and the account vector. The account vector is generated using an account embedding model.

Other aspects of the invention will be apparent from the following description and appended claims.

### BRIEF DESCRIPTION OF DRAWINGS

FIG. 1A, FIG. 1B, and FIG. 1C show diagrams of systems in accordance with disclosed embodiments.

FIG. 2A, FIG. 2B, FIG. 2C, and FIG. 2D show flowcharts in accordance with disclosed embodiments.

FIG. 3 shows an example in accordance with disclosed embodiments.

FIG. 4A and FIG. 4B show computing systems in accordance with disclosed embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

One or more embodiments are directed to addressing a cold-start problem of an automated categorization engine categorizing transactions for new entities that have limited, if any, transactions categorized into a chart of accounts. Because of the lack of categorization, new entities have insufficient data to train a machine learning model to categorize transactions into accounts of a customized chart of accounts. Moreover, because of the customizations, millions of accounts exist creating a large classification problem (e.g., each account is a class in the classification problem).

One or more embodiments address the problems by converting the problem to a binary problem rather than a multi-class classification problem. Positive samples are positive associations between transactions and accounts, i.e., the actual transactions with the account to which the entity assigned the transaction. Negative samples are negative associations, i.e., actual transactions with the account to which the transaction not assigned. In this manner, transactions and accounts are paired features and have association scores defined. The benefit is that the number of unique accounts is not needed. Instead, interactions between transactions and accounts are learned explicitly.

From a more technical perspective, to overcome the above problems, one or more embodiments are directed to using a twin tower model to generate account recommendations for categorizing transactions. A twin tower model has two machine learning models (e.g., transaction model and accounting embedding model) that map to the same vector space. Namely, the vector output of both the transaction model and the accounting embedding model have the same number of dimensions and are trained such that the degree of similarity between the output vectors is representative of the level of match of the input. Thus, for the transaction model within the twin tower model, transaction information is used as input while, for the account embedding model within the twin tower model, account information is used as input.

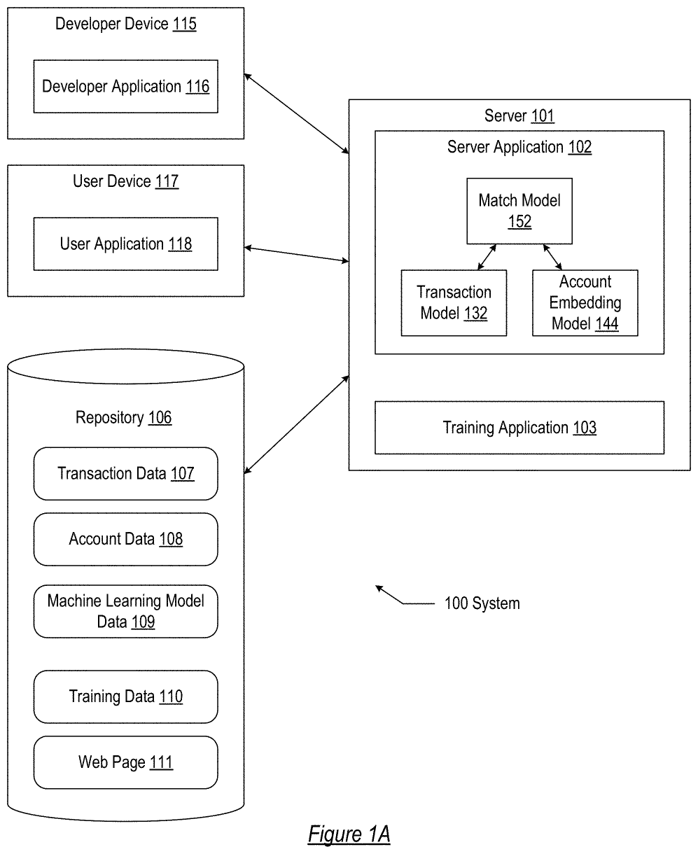

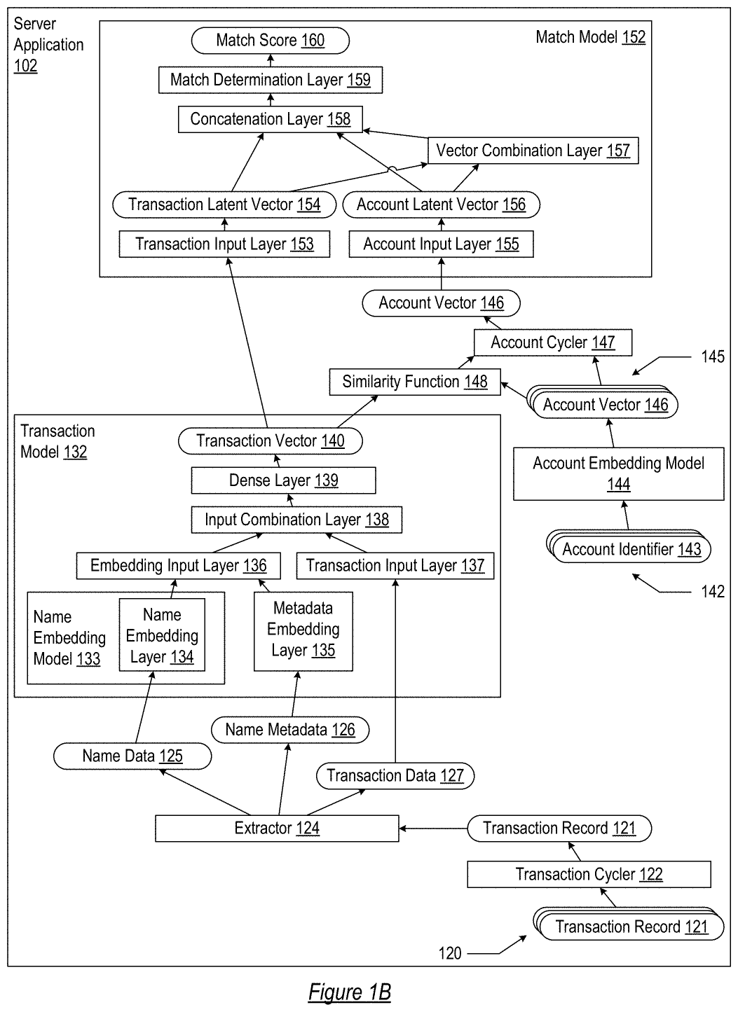

Turning to the Figures, the Figures are organized as follows. FIGS. 1A, 1B, and 1C show diagrams of embodiments that are in accordance with the disclosure. FIG. 1A shows the system (100), which trains and uses machine learning models to categorize transaction records. FIG. 1B shows the server application (102), which uses machine learning models to categorize transaction records. FIG. 1C shows the training application (103), which trains machine learning models to categorize transaction records. The embodiments of FIGS. 1A, 1B, and 1C may be combined and may include or be included within the features and embodiments described in the other figures of the application. The features and elements of FIGS. 1A, 1B, and 1C are, individually and as a combination, improvements to the technology of machine learning. The various elements, systems, and components shown in FIGS. 1A, 1B, and 1C may be omitted, repeated, combined, and/or altered as shown from FIGS. 1A, 1B, and 1C. Accordingly, the scope of the present disclosure should not be considered limited to the specific arrangements shown in FIGS. 1A, 1B, and 1C.

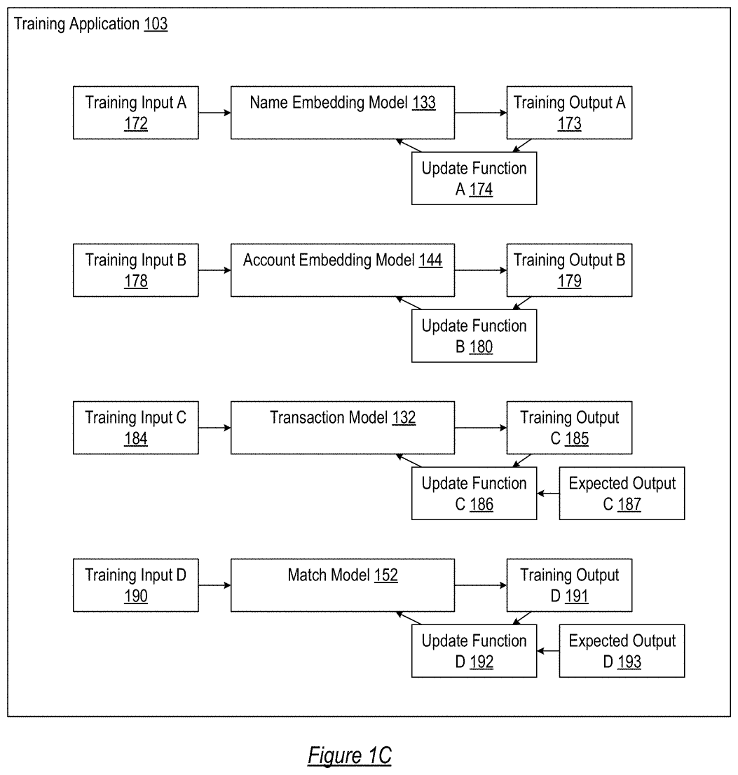

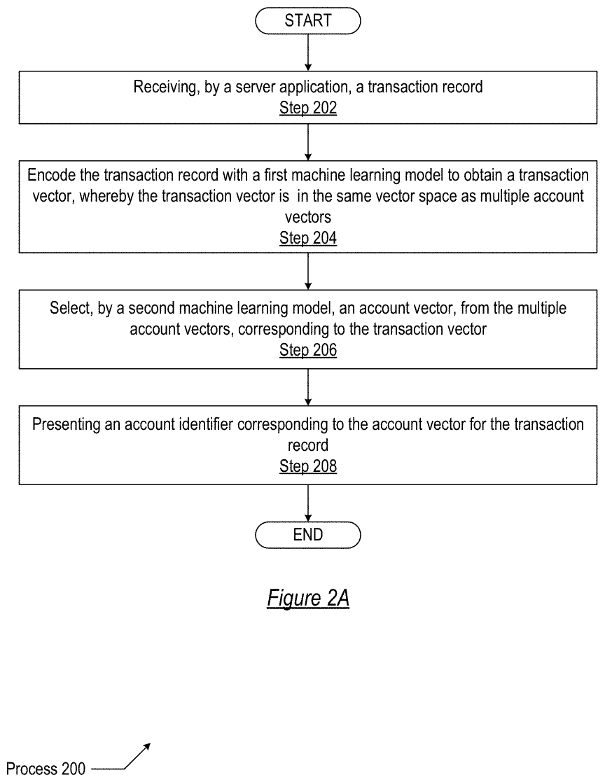

FIGS. 2A, 2B, 2C, and 2D show flowcharts of processes in accordance with the disclosure. The process (200) of FIG. 2A is a general flow for categorizing transactions using machine learning models. The process (230) of FIG. 2B and the process (250) of FIG. 2C include intermediate steps for categorizing transactions using machine learning models in accordance with at least some embodiments. The process (280) of FIG. 2D trains machine learning models used to categorize transactions using machine learning models. The embodiments of FIGS. 2A, 2B, 2C, and 2D may be combined and may include or be included within the features and embodiments described in the other figures of the application. The features of FIGS. 2A, 2B, 2C, and 2D are, individually and as an ordered combination, improvements to the technology of computing systems and machine learning systems. While the various steps in the flowcharts are presented and described sequentially, one of ordinary skill will appreciate that at least some of the steps may be executed in different orders, may be combined or omitted, and at least some of the steps may be executed in parallel. Furthermore, the steps may be performed actively or passively. For example, some steps may be performed using polling or be interrupt driven. By way of an example, determination steps may not have a processor process an instruction unless an interrupt is received to signify that condition exists. As another example, determinations may be performed by performing a test, such as checking a data value to test whether the value is consistent with the tested condition.

Turning to FIG. 1A, the system (100) includes a user device (117), a repository (106), a developer device (115), and a server (101). The server (101) may include the server application (102) and the training application (103).

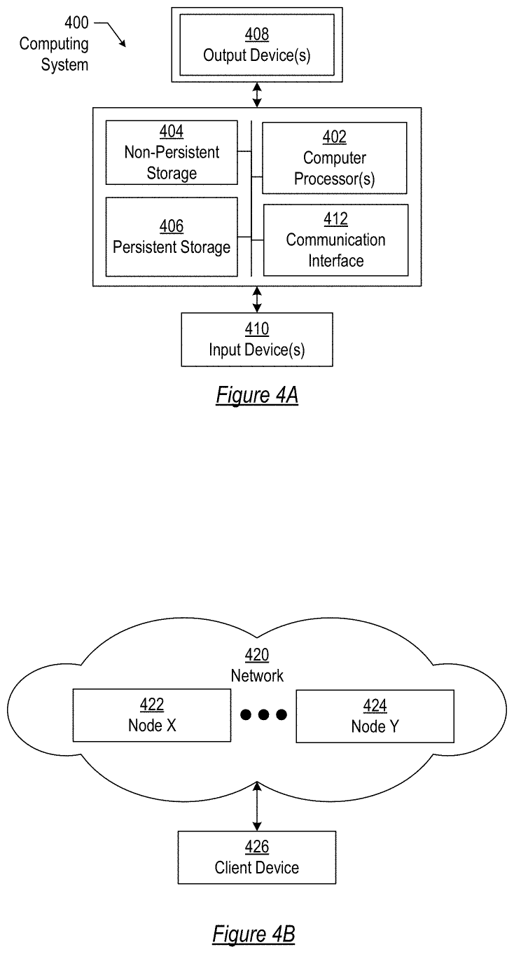

The user device (117) is an embodiment of the computing system (400) and the nodes (422 and 424) of FIG. 4A and FIG. 4B. In one embodiment, the user device (117) is a desktop personal computer (PC), a smartphone, a tablet, etc. that is used by a user. The user device (117) is used to access the web page (111) of the website hosted by the system (100). The user device (117) includes the user application (118) for accessing the server application (102). The user application (118) may be a browser, a local user level application, or another application. The user application (118) may include multiple interfaces (e.g., graphical user interfaces, application program interfaces (APIs)) for interacting with the server application (102). A user may operate the user application (118) to perform tasks with the server application (102) to interact with the system (100). The results may be presented by being displayed by the user device (117) in the user application (118).

The user may be one of multiple users that have access to a computing system on behalf of an entity (e.g., family, business organization, nonprofit organization, etc.). For example, a business may have multiple users that access the system to review the accounts of the entity. An entity may be a person or a business that utilizes the system to track accounts. In the present disclosure, the user may refer to any user operating on behalf of the entity. For example, a first user may perform a first set of accounting tasks for the entity and a second user may perform a second set of accounting tasks, such as review the accounts/process transactions for the entity. In such scenario, the user accounts are the entity's accounts on which the user is performing actions. Each user may have user device (117) to access the server application (102).

The developer device (115) is an embodiment of the computing system (400) and the nodes (422 and 424) of FIG. 4A and FIG. 4B. In one embodiment, the developer device (115) is a desktop personal computer (PC). The developer device (115) includes the developer application (116) for accessing the training application (103). The developer application (116) may include a graphical user interface for interacting with the training application (103) to control training and updating the machine learning models of the system (100).

The developer application (116) and the user application (118) may be web browsers that access the server application (102) and the training application (103) using web pages hosted by the server (101). The developer application (116) and the user application (118) may additionally be web services that communicate with the server application (102) and the training application (103) using representational state transfer application programming interfaces (RESTful APIs). Although FIG. 1A shows a client server architecture, one or more parts of the training application (103) and the server application (102) may be local applications on the developer device (115) and the user device (117) without departing from the scope of the disclosure.

The repository (106) is any type of storage mechanism or device that includes functionality to store data. The repository may include one or more hardware devices (e.g., storage servers, file systems, database servers, etc.) computing system that may include multiple computing devices in accordance with the computing system (400) and the nodes (422 and 424) described below in FIGS. 4A and 4B. The repository (106) may be hosted by a cloud services provider (e.g., that provides hosting, virtualization, and data storage services as well as other cloud services to operate and control the data, programs, and applications that store and retrieve data from the repository (106)). The data in the repository (106) may include the transaction data (107), the account data (108), the machine learning model data (109), the training data (110), and the web page (111).

The transaction data (107) is data for multiple transactions of multiple entities of the system (100). In one or more embodiments, a transaction is a financial transaction between the entity and at least one other party to the transaction. For example, the financial transaction may be between a customer of the entity and the entity. As another example, the transaction may be between a vendor of the entity and the entity. The transaction may be a commercial transaction involving the sale of one or more products (e.g., goods and/or services).

Transactions are stored as transaction records. A transaction record includes data describing a transaction. A transaction record is a text string describing a financial transaction. In one embodiment, a transaction record is for a commercial transaction and includes a name of an opposing party to the transaction, an amount of the transaction, a date of the transaction (which may include a time), and a description of the transaction. The opposing party to the transaction (i.e., opposing party) is at least one other party with which the entity performs the transaction. As such, the opposing party may be the payor or payee depending on whether the transaction is an income (i.e., involves payment to the entity) or an expense (i.e., involves the entity making payment). The description may include the name of the opposing party.

The account data (108) is data for the accounts of the multiple entities that use the system (100). An account may be a bookkeeping account that tracks credits and debits for a corresponding entity. Each entity may have a chart of accounts. The term, chart of accounts, corresponds to the standard definition used in the art to refer to the financial accounts in the general ledger of an entity. The chart of accounts is a listing of accounts that are used by the entity. Different accounts may have different tax implications and accounting implications.

For at least some entities, the chart of accounts is customized. Namely, one or more of the accounts in the chart of accounts may have different names and/or types of transactions than used by other entities. Some entities may generate a new name for the account and/or define, directly or indirectly, the particular types of transactions for the account. Each account has a corresponding unique account identifier. An account identifier is a value that uniquely identifies one of a number of accounts. Even though embodiments are directed to a cold-start problem, the entity may have a customized chart of accounts. Namely, the entity's accounts may be customized even though the entity has not yet categorized the transactions into the accounts.

In the repository (106), the account data (108) may include the charts of accounts for the entities and the account identifiers that identify the different accounts for an entity. Additionally, each account may have a precomputed account vector mapped to the account, which identifies the account. As an example, the names of the accounts may include “Reimbursable Expenses”, “Advertising and Marketing”, “Utilities”, “Sales”, “Accounts Payable”, “Accounts Receivable”, “Mortgages”, “Loans”, “Property, Plant, and Equipment (PP&E)”, “Common Stock”, “Services, “Wages and Payroll”, etc. Each transaction may be assigned to one or more of the accounts in order to categorize the transactions. Assignment of an account to a transaction may be performed by linking an account identifier of an account to a transaction record of a transaction.

Continuing with the repository, the machine learning model data (109) may include the code and data that form the machine learning models used by the system. For example, the weights of the neural network and regression models may be part of the machine learning model data (109).

The training data (110) is the data used to train the machine learning models of the system (100). The training data (110) has pairs of transaction records (e.g., historical transaction records of the entities using the system) and account identifiers that have been assigned to the transaction. Because the entity is new, the training data includes the categorization of transactions for other entities of the system. The training data (110) may also include the intermediate data generated to train and update the machine learning models of the system. The training data (110) may include the training inputs and expected outputs shown in FIG. 1C.

The data in the repository (106) may also include a web page (111) that is part of a website hosted by the system (100). The users and the developers may interact with the website using the user device (117) and the developer device (115) to access the server application (102) and the training application (103).

Continuing with FIG. 1A, a server (101) is operatively connected to the developer device (115), user device (117), and repository (106). The server (101) is a computing system and/or nodes, such as the computing system and nodes show in FIGS. 4A and 4B. Although shown as individual components, the server (101) and repository (106) may be the same device or collection of devices. The server (101) includes functionality to execute a server application (102) and a training application.

The server application (102) is a program on the server (101). The server application (102) includes multiple programs used by the system (100) to interact with the user device (117) and present data to a user of the user device (117).

The server application (102) includes a transaction model (132), an account embedding model (144), and a match model (152). The models are described below.

Briefly, the machine learning models of embodiments of the disclosure may use neural networks. Neural networks may operate using forward propagation and backpropagation. Forward propagation may include multiplying inputs to a layer of a neural network by a set of weights and summing the result to generate an output. Backpropagation is the backward propagation of error through the layers of a neural network to update the weights of the layers. The weights may be updated in response to error signals generated from the outputs of the layer. Each of the layers of the machine learning models may include multiple layers and form part of a neural network. The layers of the neural networks may include one or more fully connected layers, convolutional neural network (CNN) layers, recurrent neural network (RNN) layers, etc. Machine learning models other than neural networks may also be used in embodiments of the disclosure.

The transaction model (132) takes the transaction information as input and encodes the transaction information with a pre-trained encoder. The pre-trained encoder is trained with a regression model. The output of the transaction model is a transaction vector.

The account embedding model (144) encodes the account information to generate an account vector. The account embedding model is a pre-trained word to vector model that converts an account name to an account vector, which is the output of the account embedding model (144). For example, the account embedding model may be a word2vec model. Alternative models include GloVe developed by Stanford, fastText developed by Facebook, Inc., amongst other encoding models.

The transaction model (132) and the account embedding model (144) are in the same vector space. Being in the same vector space, transaction vectors (output from the transaction model (132)) and account vectors (output from the account embedding model (144)) that are the same or similar in value will identify the same accounts while transaction vectors and account vectors that have different values will identify different accounts. In one embodiment, the transaction model (132) may be trained independently of other models and an account vector may be used as the training output for training the transaction model (132). Thus, directly using the vector space and values of the account vectors may be performed to train the transaction model (132) to generate transaction vectors with similar values.

A match model (152) combines the outputs from the transaction model (132) and account embedding model (144). The match model (152) may have multiple multilayer perceptron (MLP) layers to combine the transaction vector and the account vector to form a match score that indicates whether the transaction vector (generated from transaction information) matches the account vector (generated from account information). Using the match model (152) instead of simply using the cosine similarity between the outputs of the transaction model (132) and the account embedding model (144) of the improves the accuracy of the system (100).

In one or more embodiments, the match model (152) uses an element-wise product to combine the transaction vector output from the transaction model (132) and the account vector output from the account embedding model (144). The element-wise product may be an input to one of the multilayer perceptron (MLP) layers. The element-wise product is conceptually similar to a cosine similarity operator. The element-wise product encourages a behavior in which positively associated pairs of transactions and categories are embedded to similar locations, and negatively associated pairs are embedded far away from each other. The shared vector space for the transaction and account vectors further allows layers in each of the models to explore patterns and structure.

The match model (152) is configured to generate a match score (not shown) for the transaction and each account of the entity's chart of accounts. The server application (102) identifies the account with the highest match score and presents that account as the recommended account for categorizing the transaction.

The training application (103) is a program on the server (101). The training application (103) trains the transaction model (132), account embedding model (144), and match model (152) as further described in FIG. 1B. The training application (103) may be operated or controlled by the developer device (115) with a developer application (116).

FIG. 2A shows a flowchart of a general process for categorizing transactions using the two-stage solution. While the various steps in the flowchart are presented and described sequentially, one of ordinary skill will appreciate that at least some of the steps may be executed in different orders, may be combined or omitted, and at least some of the steps may be executed in parallel. Furthermore, the steps may be performed actively or passively. For example, some steps may be performed using polling or be interrupt driven. By way of an example, determination steps may not have a processor process an instruction unless an interrupt is received to signify that condition exists. As another example, determinations may be performed by performing a test, such as checking a data value to test whether the value is consistent with the tested condition.

Turning to FIG. 2A, the process (200) may execute on a server to categorize transactions using machine learning models. At Step 202, a transaction record is received. The transaction record may be received by a server application in response to a request from a client device for the transaction record. For example, a client device may request a web page with a listing of transactions. The server application may generate the web page and include account identifiers, which are predicted by a machine learning model, in the web page as recommendations for which accounts should be linked to the transaction records. The transaction record received by the server application may be from a database storing the transaction records.

At Step 204, the transaction record is encoded using a first machine learning model to generate a transaction vector, the transaction vector in a same vector space as multiple account vectors. The transaction vector is generated from the transaction record with a transaction model. The transaction model is one of the machine learning models used by the system. In one embodiment, the transaction model receives name data, name metadata, and transaction data extracted from the transaction record and uses a multilayer neural network to generate the transaction vector from the name data, name metadata, and transaction data.

At Step 206, an account vector is selected from the multiple account vectors using a second machine learning model. Because the transaction vector is the same vector space as the account vectors, an initial filtering may be performed to reduce the number of account vectors considered by the match model. The match model executing in the server application may then select the account vector. In one or more embodiments, the match model operates on a binary decision process. Namely, the match model determines, for each account vector, the likelihood of a match between the account vector and the transaction vector. The account vector with the highest likelihood is selected. Thus, as compared to a classification solution whereby a model selects from multiple classes at once, one or more embodiments have the match model perform a binary classification multiple times (i.e., for each account).

In one embodiment, the account vectors are generated using an account embedding model. The account vectors may be generated independently from the transaction vector. For example, the system may map each of the available account identifiers to a respective account vector prior to executing the transaction model.

At Step 208, an account identifier is presented that corresponds to the account vector for the transaction record. In one embodiment, the account identifier may be converted from a unique numerical value to a text string that identifies the account linked to the account identifier. The text string may be incorporated into web data (extensible markup language (XML) text, hypertext markup language (HTML) text, JavaScript object notation (JSON) text, etc.) that is transmitted to a user device after the system received a request for the transaction record.

FIGS. 1B, 2B, and 2C shows a more detailed system diagrams and flowcharts in accordance with one or more embodiments. As shown, the server application (102) categorizes transaction records using multiple machine learning models. The machine learning models used by the server application (102) include the name embedding model (133), the transaction model (132), the account embedding model (144), and the match model (152). The server application (102) determines whether the transaction record (121), of the transaction records (120), matches with the account identifier (143), of the account identifiers (142) is in the match score (160).

The machine learning models within the server application (102) include several layers. In one embodiment, the machine learning models, and corresponding layers, are neural networks that process information by generating inferences from inputs using internal weights, whereby the weights are updated during training. The layers of the neural networks may include one or more fully connected layers, convolutional neural network (CNN) layers, recurrent neural network (RNN) layers, etc.

As shown in FIG. 1B, the server application (102) takes, as input, the transaction records (120) and the account identifiers (143). A transaction cycler (122) receives the transaction record. The transaction cycler (122) selects the transaction record (121) from the transaction records (120) as an input for the extractor (124). The transaction cycler (122) may iterate through the transaction records (120) in an order determined from the transaction records (120). For example, the order may be a date order, an amount order (e.g., largest to smallest), an alphabetical order (e.g., of the description or name), etc.

The extractor (124) is configured to parse the transaction record (121) and extracts data from the transaction record (121). In one embodiment, the extractor (124) is configured to extract the name data (125), the name metadata (126), and the transaction data (127) from the transaction record (121).

The name data (125) may be an identifier or name of a business that is a string. In one embodiment, the name data (125) is an opposing party name from the transaction record (121).

The name metadata (126) may be a categorical identifier of the entity identified by the name from the name data. In one embodiment, the name metadata (126) is a standard industrial classification (SIC) code linked to the opposing party identified by the name data (125).

The transaction data (127) includes data from the transaction record (121) that is not part of the name data (125) and the name metadata (126). In one embodiment, the transaction data (127) includes the date (and time) of the transaction, the amount of the transaction, etc., and may be normalized by the extractor (124) for input to the transaction model (132).

The extractor (124) is communicatively coupled, directly or indirectly, to the transaction model (132). The name data (125), name metadata (126), and the transaction data (127) are input to the transaction model (132).

The transaction model (132) is configured to generate the transaction vector (140) from the name data (125), the name metadata (126), and the transaction data (127). The transaction model (132) includes the name embedding model (133) (with the name embedding layer (134)), the metadata embedding layer (135), the embedding input layer (136), the transaction input layer (137), the input combination layer (138), and the dense layer (139).

In one embodiment, the name embedding model (133) is a neural network model that learns word associations from a corpus of text. The names may come from a large size vocabulary containing hundreds of thousands of words, and the embedding model maps each word to a fixed dimensional vector (e.g., 128-dimensions in one embodiment). The fixed dimensional vector is a name embedding vector generated from the name data (125). Thus, the name embedding model (133) is configured to generate dense features from sparse features. Sparse raw features are features that have mostly zero values and correspond to raw data. An example of sparse raw features is all of the different names of possible businesses with which an entity may perform a transaction (e.g., the names of all of the businesses in the world or in a particular country). Dense features are features are features that are mostly non-zero. For example, a dense feature may be types of the businesses (e.g., home improvement business, construction business, etc.).

When two names (e.g., the names to different opposing parties) output name embedding vectors with similar values (e.g., a cosine similarity close to 1), then the names (or the entities represented by the names) are similar (even when the words in the names are different). For example, the name embedding vectors for strings with the values of “Lowes” and “Home Depot” may be similar even though the individual names include different words and characters. “Lowes” may be short for “Lowe's”, which is a registered trademark of LF, LLC LIMITED LIABILITY COMPANY DELAWARE 1000 Lowe's Boulevard Mooresville NORTH CAROLINA 28117. “Home Depot” may be short for “The Home Depot” which is a registered trademark of Homer TLC, Inc. CORPORATION DELAWARE 2455 PACES FERRY ROAD ATLANTA GEORGIA 30339.

The metadata embedding layer (135) generates a metadata embedding vector from the name metadata (126). The metadata embedding layer (135) may be a neural network that is an encoder that includes one or more layers of fully connected nodes to generate the metadata embedding vector that is output by the metadata embedding layer (135).

The embedding input layer (136) generates an embedding input vector from the output of the name embedding model (133) and the output of the metadata embedding layer (135). The embedding input layer (136) connects the embedded features for transaction description with the output of the metadata embedding layer are each connected with a flatten/dropout layer (with dropout factor 0.2) and then concatenated together with the amount and date features. In one embodiment, the embedding input layer (136) is a neural network that includes one or more fully connected layers to generate an embedding input vector as an output.

The transaction input layer (137) generates an output from the transaction data (127). In one embodiment, the transaction input layer (137) may be a neural network that includes one or more fully connected layers to generate a transaction input vector as the output.

The input combination layer (138) generates an output from the outputs of the embedding input layer (136) and the transaction input layer (137). In one embodiment, the input combination layer (138) is a neural network that includes one or more fully connected layers to generate an input combination vector as the output of the input combination layer (138). For example, the input combination layer may be a two-layer neural network (e.g., with 512 and 256 nodes respectively).

The dense layer (139) generates the transaction vector (140) from the output of the input combination layer (138). In one embodiment, the dense layer (139) is a neural network that includes one or more fully connected layers to generate the transaction vector (140). A dense layer (139) is represented as a set of weight parameters, which has values that can be adjusted by a back-propagation algorithm. The dense layer thus allows the model to learn based on observation data. Dense layer (139) learns the weight parameters so that the transaction vector (140) regresses towards the ground truth account vector.

To train the neural network, a list of (transaction, account) pairs from entities who are deemed to have accurate assignments of accounts to transactions are used. The pairs are treated as ground truth supervision signal. The neural network then adjusts its parameters by backpropagation in order to minimize the regression error between the account vectors and the transaction vector. Effectively, the transaction model (132) learns to put transactions and accounts into the same vector space.

The account embedding model (144) generates the account vectors (145) from the account identifiers (142). The account identifiers (142) uniquely identify the accounts of a chart of accounts of an entity. In one embodiment, the account embedding model (144) is an autoencoder that generates the account vector (146) from the account identifier (143) with the account vector (146) in the same vector space as the transaction vector (140).

With the account vectors (145) in the transaction vector (140) being in the same vector space, the account vectors (145) and the transaction vector (140) have the same number of dimensions and when the transaction vector (140) as a value similar to the account vector (146), then the transaction vector (140) may be matched to the same account identifier (143) as the account vector (146). Each account in an entity's chart of accounts has a unique corresponding account vector (146) that is generated by the account embedding model (144).

The account cycler (147) selects the account vector (146) from the account vectors (145) as an input for the match model (152). In one embodiment, the account cycler (147) may iterate through the account vectors (145) in an order determined by the similarity of the account vectors (145) to the transaction vector (140) using the similarity function (148). For example, the similarity function (148) may identify the cosine similarity between the transaction vector (140) and each of the account vectors (145), which may be ordered from largest to smallest. The number of account vectors (145) that are passed to the match model (152) may be defined by a threshold (10, 20, etc.) to reduce the amount of computation used by the system (100) (shown in FIG. 1A).

The match model (152) generates the match score (160) from the transaction vector (140) and the account vector (146). The match model (152) includes the transaction input layer (153), the account input layer (155), the vector combination layer (157), the concatenation layer (158), and the match determination layer (159). In one embodiment, the match model (152) is used to generate a match score for each of the account vectors (145) selected by the account cycler (147) and, from the match scores, determine the account identifier that is a closest match for the transaction record (121).

The combination of the similarity function (148) and the match model (152) achieves the following in one or more embodiments. The transaction vector (140) and account vector (146) are in the same vector space. Thus, the similarity function (148) may be used to identify approximate matches between a transaction and accounts. Thus, the similarity function (148) operates to reduce the candidate list of accounts that may be assigned to a transaction.

However, even though the transaction vector (140) and account vector (146) are in the same vector space, measuring the degree to which a match exists is a challenge. Specifically, the vector space does not have a correct distance metric. Any linear mapping can change the distance, and the vector space may not be linear. Thus, the match model provides a finer grain model that is better able to handle the interaction between transaction vectors and account vectors.

Continuing with the match model (152), the transaction input layer (153) generates the transaction latent vector (154) from the transaction vector (140). In one embodiment, the transaction input layer (153) is a neural network that includes one or more fully connected layers to generate the transaction latent vector (154). The transaction latent vector (154) is an intermediate layer output. The transaction input layer (153) provides an additional set of parameters, whose weights can be adjusted. Use of the transaction latent vector (154) instead of the transaction vector (140) improves the accuracy of the output of the match model (152).

The account input layer (155) generates the account latent vector (156) from the account vector (146). In one embodiment, the account input layer (155) is a neural network that includes one or more fully connected layers to generate the account latent vector (156). Use of the account latent vector (156) instead of the account vector (146) improves the accuracy of the output of the match model (152).

The vector combination layer (157) generates an output from the transaction latent vector (154) and the account latent vector (156). In one embodiment the vector combination layer (157) is a neural network that includes one or more fully connected layers to generate a latent combination vector as the output of the vector combination layer (157).

The concatenation layer (158) generates an output from the transaction latent vector (154), the account latent vector (156), and the output of the vector combination layer (157) (refer to as a latent combination vector). In one embodiment, the concatenation layer (158) concatenates the inputs to the concatenation layer (158) to generate a concatenation vector as the output of the concatenation layer (158). The concatenation vector may include the transaction latent vector (154), the account latent vector (156), and the latent combination vector from the vector combination layer (157) as separate channels of the concatenation vector that is output by the concatenation layer (158).

The match determination layer (159) generates the match score (160) from the output of the concatenation layer (158) (the concatenation vector). In one embodiment, the match score (160) is a scalar value that identifies how well an account vector (146) matches the transaction vector (140).

Turning to FIG. 2B, the process (230) may be intermediate steps that execute on a server to categorize transactions using machine learning models. At Step 232, name data is extracted from the transaction record. The name data may be a string extracted from a field of the transaction record. In one embodiment, the field is an opposing party name field that identifies the opposing party the transaction described by the transaction record. In one embodiment, the field may be a description field and the named data may be a subset of the description field that is matched against a list of opposing party names.

At Step 234, a name embedding vector is generated from the name data using a name embedding model. The name embedding model includes a name embedding layer of the transaction model. The name embedding model may be incorporated as part of the transaction model during execution of the transaction model. In one embodiment, the name data is passed through the name embedding layer of the name embedding model using forward propagation to generate the name embedding vector.

At Step 236, name metadata and transaction data are extracted from the transaction record. The name metadata may be extracted by extracting an opposing party name from the transaction record, querying a datastore for a standard industrial classification (SIC) code for the opposing party name from a database mapping opposing party names to SIC codes, and converting the code to a sparse vector. The transaction data may include the date and amount of the transaction from the transaction record, which may be normalized and may be passed in as elements of a vector to the transaction model.

At Step 238, a metadata embedding vector is generated from the name metadata using a metadata embedding layer of the transaction model. The metadata embedding vector may be a dense vector generated from the sparse vector that is the name metadata. In one embodiment, the name metadata is passed through the metadata embedding layer using forward propagation to generate the metadata embedding vector.

At Step 240, an embedding input vector is generated from a name embedding vector and the metadata embedding vector using an embedding input layer of the transaction model. In one embodiment, the name embedding vector and the metadata embedding vector are passed through the embedding input layer using forward propagation to generate the embedding input vector.

At Step 242, a transaction input vector is generated from the transaction data using a transaction input layer of the transaction model. In one embodiment, the transaction data is passed through the transaction input layer using forward propagation to generate the transaction input vector.

At Step 244, an input combination vector is generated from the embedding input vector and the transaction input vector using an input combination layer of the transaction model. In one embodiment, the embedding input vector and the transaction input vector are passed through the input combination layer to generate the input combination vector.

At Step 246, the transaction vector is generated from the input combination vector using a dense layer of the transaction model. In one embodiment, the input combination vector is passed through the dense layer using forward propagation to generate the transaction vector.

Turning to FIG. 2C, the process (250) may be intermediate steps that execute on a server to categorize transactions using machine learning models. At Step 252, an account vector is generated from an account identifier using an account embedding model. The account vector may be generated prior to the transaction.

The account vector may be a dense vector generated from the sparse vector representing the account name obtained from the account identifier. In one embodiment, the sparse vector representing the account identifier is passed through the account embedding model using forward propagation to generate the account vector.

At Step 254, a transaction latent vector is generated from the transaction vector using a transaction input layer of the match model. In one embodiment, the transaction vector is passed through the transaction input layer using forward propagation to generate the transaction latent vector.

At Step 256, an account latent vector is generated from the account vector using an account input layer of the match model. In one embodiment, the account vector is passed through the account input layer using forward propagation to generate the account latent vector.

At Step 258, a vector combination vector is generated from the transaction latent vector and the account latent vector using a vector combination layer of the match model. In one embodiment, the transaction latent vector and the account latent vector are passed through the vector combination layer using forward propagation to generate the vector combination vector.

At Step 260, a concatenation vector is generated from the transaction latent vector, the account latent vector, and the vector combination vector, using a concatenation layer of the match model. In one embodiment, the transaction latent vector is appended to the account latent vector, which is appended to the vector combination vector to form the concatenation vector by the concatenation layer.

At Step 262, a match score is generated from the concatenation vector using a match determination layer of the match model. In one embodiment, the concatenation vector is passed through the match determination layer using forward propagation to generate the match score.

At Step 264, a set of match scores are generated for a set of account vectors using the transaction vector and the set of account vectors. The set of account vectors may be a filtered set of account vectors that are closest in value to the transaction vector generated with the transaction model.

At Step 266, an account vector is selected from a set of account vectors based on a match score for the account vector. In one embodiment, the account vector corresponding to a highest match score is selected.

Turning to FIG. 1C, the training application (103) trains the machine learning models used by the system (100) (shown in FIG. 1A). In one embodiment, the machine learning models used by the system (100) (shown in FIG. 1A) are neural networks that take training inputs, generate training outputs from the training inputs, use an update function to compare the training output to an expected output, and update the machine learning models in accordance with the errors between the training outputs and the expected outputs. Each of the machine learning models (including the name embedding model (133), the account embedding model (144), the transaction model (132), and the match model (152)) of the system (100) (shown in FIG. 1A) may be trained independently.

The name embedding model (133) may be trained with unsupervised learning and generates an embedding dictionary mapping words in the name data to a fixed dimensional vector space based on the training input A (172) which contains the co-occurrence of name data items from any user's accounts. The update function A (174) adjusts the embedding vector space so that names co-occurring in an account are embedded in close by locations, and names that do not co-occur together are embedded in locations far away from each other. An iterative backpropagation process is used to minimize the objective function. In one embodiment, the name embedding model (133) is trained using a modified word2vec algorithm. Instead of learning word associations using sentences, the training application (103) for the name embedding model (133) creates “sentences” from groups of opposing party names from transactions that have been assigned to the same account identifier. In one embodiment, the training input A (172) may be name data (from FIG. 1B) that is used for training purposes (e.g., an opposing party name) and the expected output may be a different opposing party name from the sentence created by the training application (103). The training data for the name embedding model (133) may include name data for transactions from multiple entities for which the system (100) (shown in FIG. 1A) is used.

The account embedding model (144) generates an embedding dictionary mapping words in account names to a fixed dimensional vector space from the training input B (178). The update function B (180) iteratively updates the account embedding model (144), which may be done using backpropagation. In one embodiment, the training input B (178) may contain lists of account names associated with the same opposing party names. A modified word2vec algorithm is used to adjust the embedding based on the list of similar account names in the training input B (178).

The transaction model (132) generates the training output C (185) from the training input C (184). The update function C (186) compares the training output C (185) to the expected output C (187) and iteratively updates the transaction model (132), which may be done using backpropagation. In one embodiment, the training input C (184) may be data extracted from a transaction record and the expected output C (187) is an account vector that was assigned to the transaction record from which the training input C (184) is derived. In one embodiment, training the transaction model (132) does not update the weights of the name embedding model (133) (i.e., the weights of the name embedding layer (134) shown in FIG. 1B, which forms a part of the transaction model (132).

The match model (152) generates the training output D (191) from the training input D (190). The update function D (192) compares the training output D (191) to the expected output D (193) and iteratively updates the match model (152), which may be done using backpropagation. In one embodiment, the match model (152) is trained using the transaction model (132) and the account embedding model (144) using a transaction record and an account identifier as inputs and a match score between the transaction record and the account identifier (e.g., 0 no match or 1 yes match) as the expected output D (193). Positive samples (1, yes match) in the expected output D (193) are taken from real observations in history, while negative samples (0, no match) is generated via a negative sampling algorithm, which generates samples of unobserved pairs of transactions and accounts.

In one embodiment, the transaction model (132) may be trained in conjunction with the match model (152) using backpropagated feedback from the match model (152) train the transaction model (132) and indirectly cause the transaction vectors and the account vectors to share the same vector space. For example, when a training output for the match model (152) indicates a match between a transaction (and the corresponding transaction vector generated from the transaction) and an account (and the corresponding account vector generated from the account), the updates to the weights of the match model may cause the value of the transaction vector output from the updated transaction model to be closer to the value of account vector.

Additionally, the system (100) may also train the transaction model (132), the match model (152), and the account embedding model (144) at the same time. When the transaction model (132), the match model (152), and the account embedding model (144) are trained together, the transaction model (132) and the account embedding model (144) are updated with backpropagated feedback form the match model (152). When a training output for the match model (152) indicates a match between the transaction vector and the account vector, the transaction model (132) and the account model (144) may be updated to generate values for their respective transaction vectors and account vectors that are similar to each other. When a training output for the match model (152) indicates that a match does not exist between the transaction vector and the account vector, the transaction model (132) and the account embedding model (144) may be updated to generate values for their respective transaction vectors and account vectors that are not similar and are separated by a larger distance in the shared vector space between the transaction vectors and the account vectors.

Turning to FIG. 2D, the process (280) trains machine learning models used to categorize transactions using machine learning models. The machine learning models are trained by receiving inputs, passing the inputs through the layers of the models to generate outputs using forward propagation, comparing the outputs with expected outputs to generate error signals, and adjusting the weights of the model using the error signals.

At Step 282, a name embedding model is trained to generate name embedding vectors from name data using an update function of the name embedding model. The name embedding model may be trained independently of the other machine learning models of the system. Transaction descriptions are obtained. Sentences are constructed out of the transaction descriptions. Similar transactions are collected, whereby similarity means satisfying the following conditions: (i) from the same user, (ii) associated with the same account category, and (iii) occurring within 6 months of each other. Collating the words from the collection of similar transactions produces a sentence. For example, the names of different companies in home improvement and building supply businesses may be combined together to form a sentence. As another example, the names of restaurants and food delivery companies may be combined to form another sentence for meal related collections. From the sentences, word2vec may use a shallow neural network to learn a word embedding such that words in the same context are embedded close by locations.

At Step 284, an account embedding model is trained to generate account vectors from account identifiers using an update function of the account embedding model. The account embedding model may be trained independently of the other machine learning models of the system. The training may be done across multiple entities with customized charts of accounts. Even when the accounts that customers use are customized, there may still be similarities between the names and identifiers of the accounts of which the training may take advantage. For this reason, although there is not a direct match between the training data and the actual chart of accounts for an entity, the trained account embedding model is still able to generate useful account vectors from the entity's customized chart of accounts.

To train the account embedding model, a same or similar approach is taken as with training the name embedding model. Each account has a name, e.g., “Meals and entertainment”, “Cars and Trucks”, and “Utilities”. Preliminary text processing steps are taken to normalize text and remove special characters (e.g., “&”, “:”, “-”) and stop words (e.g., “and”, “of”, “the”). Multiple accounts associated with the same transaction vendor form a sentence. Thus, a sentence may be one or more account names. Thus, if a first entity associates a particular vendor with “meals and entertainment” account and a second entity associates the vendor with “business development” account, then the sentence may be “meals entertainment business development.” From the account sentences, word2vec embedding in a vector space is trained.

As shown, the name embedding model and the account embedding model are symmetrically trained. The name embedding model uses transactions that are grouped based on being associated with the same account and the account embedding model is trained by using accounts associated with the same type of transaction.

At Step 286, a transaction model is trained to generate transaction vectors from the transaction records using an update function of the transaction model. The inputs for training the transaction model include training data extracted from transaction records and the expected outputs include account vectors mapped to the transaction records. During training, the weights of the layers of the transaction model may be updated using backpropagation with error signals generated from the layers of a match model. In one embodiment, a name embedding model, within the transaction model, may be trained as part of the transaction model.

In one embodiment, the transaction model may be trained independently of the other models of the system and after the account embedding model is trained. For example, an input may be a transaction record and the expected output an account vector (generated by the account embedding model) that corresponds to the account to which the transaction was assigned. In this case, the transaction model may be trained independently of and without the match model.

At Step 288, a match model is trained to generate match scores from transaction vectors and account vectors using an update function of the match model. The match model may train contemporaneously with the transaction model, the name embedding model, and the account embedding model. Error signals generated using backpropagation from the match model may be propagated back to update waits in the transaction model, the account embedding model, and the name embedding model.

In one or more embodiments, the match model is a collection of binary classifications. In such embodiments, training the match model may use both positive and negative matches. Positive samples are match: the user actually has assigned a transaction into an account; negative samples are non-match: the user has never assigned the transaction into the account. Thus, transactions and accounts are paired and the scores of the association between the account and transaction is determined. As compared to the multi-class classification approach, the binary match or nonmatch formulation enjoys the benefit that the number of unique accounts and instead can directly learn the interactions between transactions and accounts explicitly. The trade-off is binary classifications uses negative sampling and may lead to heavier computation.

Although the match model is described as performing binary classifications, a multi-class model may be used as the match model without departing from the scope of the invention unless specifically claimed.

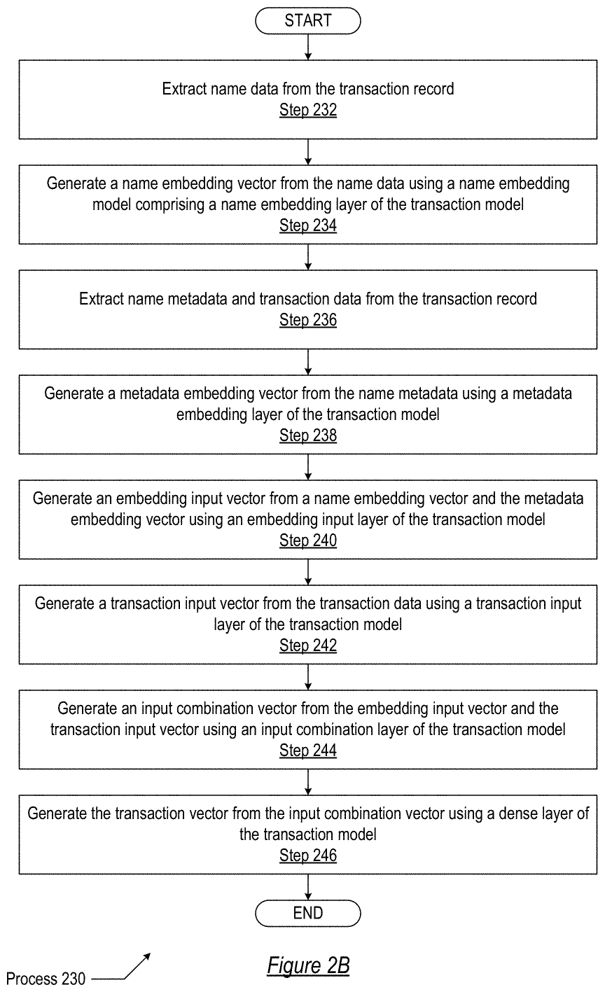

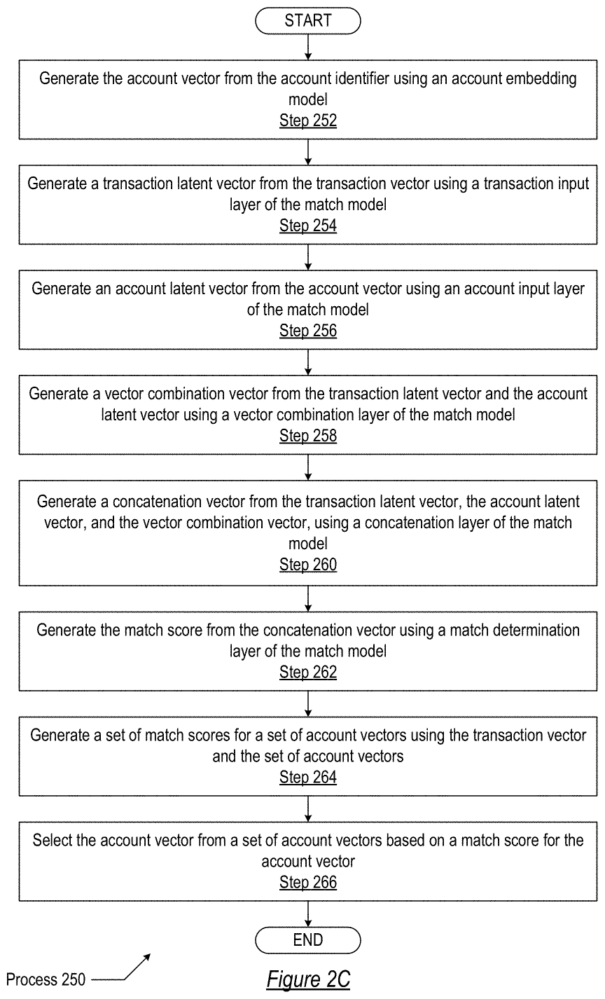

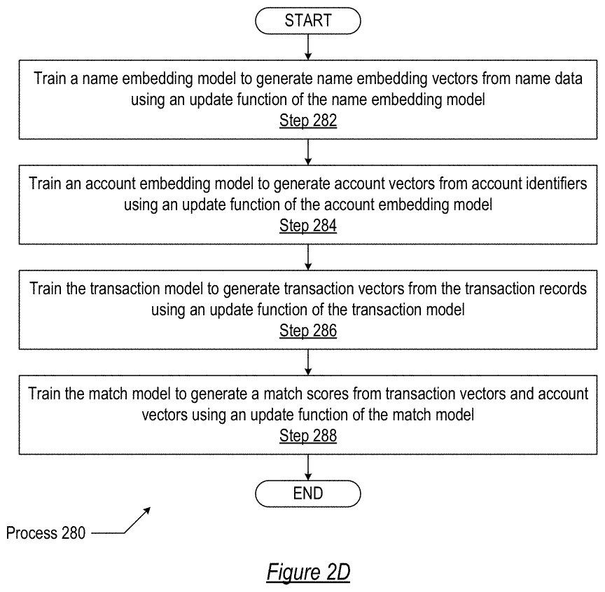

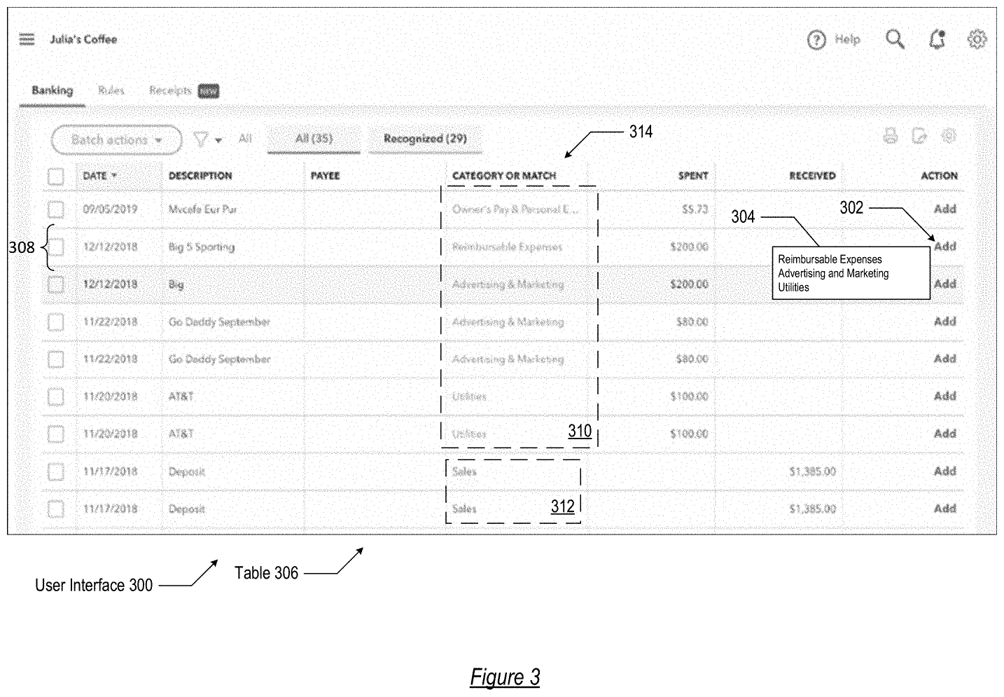

FIG. 3 shows an example of a user interface for a system that categorizes transaction records in accordance with the disclosure. The embodiments shown in FIG. 3 may be combined and may include or be included within the features and embodiments described in the other figures of the application. The features and elements of FIG. 3 are, individually and as a combination, improvements to the technology of computing systems and machine learning systems. The various features, elements, widgets, components, and interfaces shown in FIG. 3 may be omitted, repeated, combined, and/or altered as shown. Accordingly, the scope of the present disclosure should not be considered limited to the specific arrangements shown in FIG. 3.

Turning to FIG. 3, the user interface (300) may be displayed on a client device. The user interface (300) includes multiple user interface elements (referred to as elements) that allow for action with the transaction records stored by the system. In one embodiment, the user interface (300) is a browser displaying a webpage. With the user interface (300), a user may inspect or select the account it had been assigned to the transaction records displayed within the table (306). Each of the machine learning models used by the system may be trained prior to use in conjunction with display of the user interface (300).

The user interface (300) displays a list of transaction records in the table (308). The table (306) includes the row (308). The transaction records are displayed in several rows and columns with a row for each transaction record and columns for different types of data within a transaction record. In the example of FIG. 3, the opposing party name of a transaction record is part of the description field of the transaction record and has not been extracted to an opposing party field of the transaction record.

The column (314) displays account data from a category field of a transaction record. The account data displayed in the column (314) includes text strings that describe the accounts that may be linked to the transaction records displayed in the table (306). The account data displayed within portion (310) of the column (314) are for accounts that have not been automatically matched to transaction records where match scores that did not reach an assignment threshold. Account data displayed within the portion (312) of the column (314) are for accounts that have been automatically matched and linked to transaction records by having match scores that met the assignment threshold. The assignment threshold may be a scalar value to which the match score is compared and when the match score exceeds the assignment threshold, the account may be automatically linked to the transaction record. When the match score does not exceed the assignment threshold, the account may be provided as a recommendation to the user.

Upon selection of the element (302) of the row (308), the menu (304) is displayed. The menu (304) includes three options for accounts that may be assigned to the transaction record of the row (308). The text strings displayed in the menu (304) are linked to accounts that may be possible matches for the transaction of the row (308). Selection of one of the text strings from the menu (304) assigns the account linked to the text string to the transaction of the row (308).

To identify the items in the menu (304), the transaction record of the row (308) is input to a machine learning model to generate the account identifiers found in the menu (304). For example, the transaction record of the row (308) may correspond to the transaction record (121) of FIG. 1B from which the name data (125), the name metadata (126), and the transaction data (127) are extracted using the extractor (124).

The name data (125), the name metadata (126), and the transaction data (127) are input to the transaction model (132), which generates the transaction vector (140). An account vector from the chart of accounts of the entity is selected as the account vector (146) and is input with the transaction vector to the match model (152). The match model (152) generates the match score (160) from the transaction vector (140) and the account vector (146). The match score (160) identifies how well the transaction vector (140) and the account vector (146) match. Account vectors which are a closer match to the transaction vector (140) may have a higher match score. The system identifies the three accounts with the highest match scores and uses those accounts as the items in the menu three or four of FIG. 3.

The items in the menu (304) may be sorted in order of increasing match score (308). The account vector for the account with the text string “reimbursables expenses” is indicated (by placement at the top of the menu (304)) as being better matches for a transaction vector generated from the transaction record of the row (308).

The account vector is generated using an account embedding model. The account embedding model receives an account identifier for the account as an input and outputs the account vector.

The transaction vector is generated using a transaction model. The transaction model receives data extracted from the transaction record as input and outputs the transaction vector.

The account vector and the transaction vector are compared with a match determination model that takes the account vector and the transaction vector as inputs and outputs a match score. The match score is compared with other match scores (generated using the transaction vector and other account vectors as inputs to the match determination model). The account with the account vector having the highest match score is displayed at the top of the menu (304).

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities that implement the features and elements of the disclosure.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (400) in FIG. 4A may be connected to or be a part of a network. For example, as shown in FIG. 4B, the network (420) may include multiple nodes (e.g., node X (422), node Y (424)). Each node may correspond to a computing system, such as the computing system shown in FIG. 4A, or a group of nodes combined may correspond to the computing system shown in FIG. 4A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4A. Further, the client device (426) may include and/or perform all or a portion of one or more embodiments of the invention.

The computing system or group of computing systems described in FIGS. 4A and 4B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 4A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 4A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 4A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g., join, full join, count, average, etc.), sorts (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 4A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4A and the nodes and/or client device in FIG. 4B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
receiving, by a server application, a transaction record;
encode the transaction record with a first machine learning model to obtain a transaction vector, wherein the transaction vector is in a same vector space as a plurality of account vectors;
selecting, by a second machine learning model executing in the server application, an account vector, from the plurality of account vectors, corresponding to the transaction vector; and
presenting an account identifier corresponding to the account vector for the transaction record.

2. The method of claim 1, wherein generating the transaction vector further comprises:
extracting name data from the transaction record;
generating a name embedding vector from the name data using a name embedding model comprising a name embedding layer of the transaction model.

3. The method of claim 1, wherein generating the transaction vector further comprises:
extracting name metadata and transaction data from the transaction record;
generating a metadata embedding vector from the name metadata using a metadata embedding layer of the transaction model;
generating an embedding input vector from a name embedding vector and the metadata embedding vector using an embedding input layer of the transaction model;
generating a transaction input vector from the transaction data using a transaction input layer of the transaction model;
generating an input combination vector from the embedding input vector and the transaction input vector using an input combination layer of the transaction model; and
generating the transaction vector from the input combination vector using a dense layer of the transaction model.

4. The method of claim 1, wherein generating the transaction vector further comprises:
generating a transaction latent vector from the transaction vector using a transaction input layer of the match model;
generating an account latent vector from the account vector using an account input layer of the match model;
generating a vector combination vector from the transaction latent vector and the account latent vector using a vector combination layer of the match model;
generating a concatenation vector from the transaction latent vector, the account latent vector, and the vector combination vector, using a concatenation layer of the match model; and
generating the match score from the concatenation vector using a match determination layer of the match model.

5. The method of claim 1, wherein selecting the account vector further comprises:
generating a set of match scores for a set of account vectors using the transaction vector and the set of account vectors; and
selecting the account vector from a set of account vectors based on a match score for the account vector.

6. The method of claim 1, further comprises:
generating the account vector from the account identifier using an account embedding model.

7. The method of claim 1, further comprises:
training the transaction model to generate transaction vectors from the transaction records using an update function of the transaction model.

8. The method of claim 1, further comprises:
training the match model to generate match scores from transaction vectors and account vectors using an update function of the match model.

9. The method of claim 1, further comprises:
training a name embedding model to generate name embedding vectors from name data using an update function of the name embedding model.

10. The method of claim 1, further comprises:
training an account embedding model to generate account vectors from account identifiers using an update function of the account embedding model.

11. A system comprising:
a server comprising one or more processors and one or more memories; and
an application, executing on one or more processors of the server, configured for:
receiving, by the application, a transaction record;
generating a transaction vector from the transaction record with a transaction model;
selecting, by a match model executing in the application, an account vector, from a plurality of account vectors, corresponding to the transaction record using the transaction vector and the account vector, wherein the account vector is generated using an account embedding model; and
presenting an account identifier corresponding to the account vector for the transaction record.

12. The system of claim 11, wherein generating the transaction vector further comprises:
extracting name data from the transaction record;
generating a name embedding vector from the name data using a name embedding model comprising a name embedding layer of the transaction model.

13. The system of claim 11, wherein generating the transaction vector further comprises:
extracting name metadata and transaction data from the transaction record;
generating a metadata embedding vector from the name metadata using a metadata embedding layer of the transaction model;
generating an embedding input vector from a name embedding vector and the metadata embedding vector using an embedding input layer of the transaction model;
generating a transaction input vector from the transaction data using a transaction input layer of the transaction model;
generating an input combination vector from the embedding input vector and the transaction input vector using an input combination layer of the transaction model; and
generating the transaction vector from the input combination vector using a dense layer of the transaction model.

14. The system of claim 11, wherein generating the transaction vector further comprises:
generating a transaction latent vector from the transaction vector using a transaction input layer of the match model;
generating an account latent vector from the account vector using an account input layer of the match model;
generating a vector combination vector from the transaction latent vector and the account latent vector using a vector combination layer of the match model;
generating a concatenation vector from the transaction latent vector, the account latent vector, and the vector combination vector, using a concatenation layer of the match model; and
generating the match score from the concatenation vector using a match determination layer of the match model.

15. The system of claim 11, wherein selecting the account vector further comprises:
generating a set of match scores for a set of account vectors using the transaction vector and the set of account vectors; and
selecting the account vector from a set of account vectors based on a match score for the account vector.

16. The system of claim 11, wherein the application is further configured for:
generating the account vector from the account identifier using an account embedding model.

17. The method of claim 11, further comprises:
training a name embedding model to generate name embedding vectors from name data using an update function of the name embedding model; and
training the transaction model to generate transaction vectors from the transaction records using an update function of the transaction model.

18. The method of claim 11, further comprises:
training the match model to generate match scores from transaction vectors and account vectors using an update function of the match model.

19. The method of claim 11, further comprises:
training an account embedding model to generate account vectors from account identifiers using an update function of the account embedding model.

20. A method comprising:
training a transaction model to generate a plurality of transaction vectors from a plurality of transaction records using an update function of the transaction model;
training the match model to generate match scores from the plurality of transaction vectors and a plurality of account vectors using an update function of the match model;
generating a transaction vector, of the plurality of transaction vectors, with the transaction model from a transaction record of the plurality of transaction records; and
generating a set of match scores for a set of account vectors, including the plurality of account vectors, using the match model.
